(19) United States
(12) Patent Application Publication
(10) Pub. No.: US 2010/0119215 A1
(43) Pub. Date: May 13, 2010

(54) Video spoiler alert

(75) Inventors: Windy Chien, San Francisco, CA (US); Gary Stewart, Santa Monica, CA (US); Robert Kondrk, Los Angeles, CA (US)

Correspondence Address: Morgan Lewis & Bockius LLP/ AI, 2 Palo Alto Square, 3000 El Camino Real, Suite 700, Palo Alto, CA, 94306, US

(73) Assignee: Apple Inc.

(21) Appl. No.: 12/292,084

(22) Filed: Nov. 12, 2008

(51) Int. Cl. H04N 7/26

(52) U.S. Cl. 386/124; 386/E05.001

(57) ABSTRACT

A system in accordance with the present invention may include one or more processors, memory that receives instructions from the one or more processors according to a clock operating at a frequency, one or more programs stored in the memory, with instructions to: open a media file that may be stored locally or remotely; play the content of the media file at a default speed; and control access to the non-played content of the media file according to one or more conditions, which may be used to prevent the spoilage or viewing ahead of the non-played content.

### FIELD OF INVENTION

The present invention relates generally to the field of media and, in particular, to playing, viewing, and controlling video or other media.

### BACKGROUND OF INVENTION

Current media players may be used for playing live or pre-recorded content, which may be played by streaming the content over the Internet to a media player, or loading the content (e.g., source media file) from a local media storage device to a media player. Content may be comprised of audio, video, slideshow pictures, or any combinations thereof. Content may be represented according to one of many media file types (e.g., MP3, M3U, MPEG(-1, -2, -4), QuickTime Movie, AU, MIDI, JPEG, GIF, TIFF). Media players today also may offer features for controlling content, even during play. For example, media players today may offer features for playing content at a normal or accelerated speed, reverse playing content at a normal or accelerated speed, pausing the play of content, forwarding or reversing paused content, and skipping-over active content to new content. However, current media players do not provide a feature, by default or according to one or more conditions, for preventing: the skipping-over of active content, forwarding of paused content, or playing of content at an accelerated speed. Moreover, current media players also do not provide a feature, by default or according to one or more conditions, for preventing the spoilage or viewing of content ahead, or alerting the viewer of the possibility of such spoilage or viewing of content ahead. Also, because current media players do not provide at least such features, they do not provide for disabling such features, by default or according to one or more conditions.

### SUMMARY OF THE INVENTION

Accordingly, the present invention is directed to a system and method for playing and controlling content that substantially obviates one or more problems due to limitations and disadvantages of the related art.

An embodiment of the present invention provides a computer-implemented method for playing content of a media file comprising opening a media file, wherein the media file is stored locally or remotely; playing content of the media file at a default speed; and controlling access to non-played content of the media file according to a condition.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system comprises one or more processors; memory; one or more programs stored in memory, the one or more programs comprising instructions to: open a media file, wherein the media file is stored locally or remotely; play content of the media file at a default speed; and control access to non-played content of the media file according to a condition, wherein the condition is used to prevent spoilage or viewing ahead of the non-played content.

In another aspect, a computer-readable storage medium stores one or more programs configured for execution by a computer, the one or more programs comprising instructions to: open a media file, wherein the media file is stored locally or remotely; play content of the media file at a default speed; and control access to non-played content of the media file according to a condition, wherein the condition is used to prevent spoilage or viewing ahead of the non-played content.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 is a block diagram illustrating an exemplary system in accordance with the present invention;

FIG. 2 illustrates an exemplary embodiment of a media player user interface pre-indicator in accordance with the present invention;

FIG. 2A illustrates an exemplary embodiment of a media player user interface post-indicator in accordance with the present invention;

FIG. 3 illustrates an exemplary embodiment of a media player user interface with indicator in accordance with the present invention;

FIG. 3A illustrates an exemplary embodiment of a media player user interface without indicator in accordance with the present invention;

FIG. 4 illustrates an exemplary system block diagram in accordance with the present invention; and

FIG. 5 illustrates an exemplary module block diagram in accordance with the present invention.

### DETAILED DESCRIPTION

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of standalone system or client-server compatible system containing any type of client, network, server, and database elements.

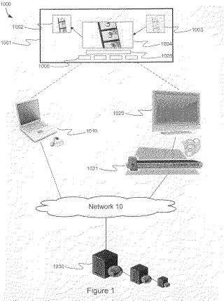

FIG. 1 is a block diagram illustrating an exemplary system 1000 in accordance with the present invention. The exemplary system 1000 comprises a computer 1010, and/or a television or other display device 1020 connected to a receiver or other media device 1021, both of which may further be connected to a network 10 (e.g., Wide Area Network (WAN), Metropolitan Area Network (MAN), or Local Area Network (LAN)) over a wired (e.g., TCP/IP over Ethernet, IEEE 802.3) or wireless (e.g., WiFi (802.11), GSM, GPRS, W-CDMA, EDGE, or the like) communications protocol/layer. The network 10 may further be connected to one or more servers 1030 with access to one or more media storage devices (e.g., storage servers, databases, or the like). The servers 1030 may receive requests over the network 10 to retrieve and transmit one or more media files that may contain media content (e.g., movies/videos, live/recorded television (TV) programming, pictures, music, or the like). Alternatively, the computers 1010 and/or receivers or other media devices 1021 may load media files locally from storage (e.g., hard drive, flash drive, CD-ROM/RW, tape drive, solid state memory, or the like), or via a connection to one or more other computers or servers (e.g., remotely).

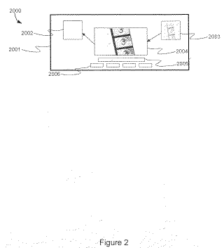

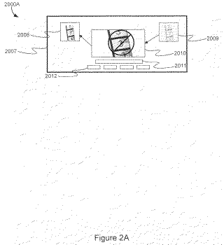

FIG. 2 illustrates an exemplary embodiment of a media player user interface pre-indicator in accordance with the present invention, and FIG. 2A illustrates an exemplary embodiment of a media player user interface post-indicator in accordance with the present invention. The sequence between media player user interfaces 2001 and 2007 is intended to illustrate the prevention of access to content that has not yet been viewed in sequence (“non-played content”) and the use of an indicator. An exemplary instance of the media player user interface 2001 comprises an active content 2004 window without a restrictive indicator, a non-played content window 2003, a previously played content window 2002, a set of additional non-played content 2006, and descriptive text/information 2005. Another exemplary instance of the media player user interface 2007 comprises an active content 2010 window with a restrictive indicator, a non-played content window 2009, a previously played content window 2008, a set of additional non-played content 2012, and descriptive text/information 2011. Not all of these elements of the exemplary instances of media player user interfaces 2001, 2007 are necessarily required for their proper operation.

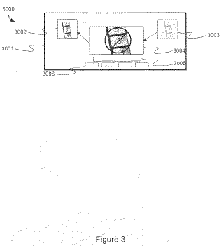

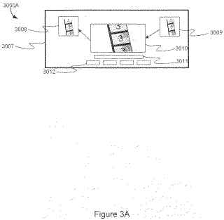

FIG. 3 illustrates an exemplary embodiment of a media player user interface with indicator in accordance with the present invention, and FIG. 3A illustrates an exemplary embodiment of a media player user interface without indicator in accordance with the present invention. The sequence between media player user interfaces 3001 and 3007 is intended to illustrate the allowance of access to non-played content and the lifting of an indicator. An exemplary instance of the media player user interface 3001 comprises an active content 3004 window with a restrictive indicator, a non-played content window 3003, a previously played content window 3002, a set of additional non-played content 3006, and descriptive text/information 3005. Another exemplary instance of the media player user interface 3007 comprises an active content 3010 window without a restrictive indicator, a non-played content window 3009, a previously played content window 3008, a set of additional non-played content 3012, and descriptive text/information 3011. Not all of these elements of the exemplary instances of media player user interfaces 3001, 3007 are necessarily required for their proper operation.

In some embodiments, media files are loaded locally from storage or remotely and may subsequently be opened by a media player 1001 (FIG. 1). The media player 1001 may be a standalone program running on the computer 1010 or the receiver or other media device 1021. Alternatively, the media player 1001 may be executed within a browser or other program and may access media files stored locally or remotely. The contents of a loaded media file being played by the media player 1001 may be displayed via the screen of the computer 1010 or the TV 1020 or other display device. The media player 1001 may play the contents of the media file in sequence order from the first frame to the last frame and the user/viewer may enjoy the current content being played 1004.

In some embodiments, the media player 1001 may play the media file contents at a default speed (e.g., at a specific frame(s)/second(s) rate), which may depend on the type of media file and/or the media file's contents. In addition, before, during, or after playing the contents of a media file, the control functions and features of the media player 1001 may be used to accelerate the speed at which the content of an opened media file is played. The control functions and features of the media player 1001 may further be used to pause the playing of media file content, skip-over content of the media file, and/or reverse-play content of the media file.

In some embodiments, the media player 1001 may include a feature for setting conditions that may control viewer access to non-played content of a loaded media file. For example, in FIGS. 1-2, the media player 1001 presents an implementation where the next frame in sequence for the loaded media file is rendered blurred 1003 because there is active content 1004 being played. For example, if the user wants to fast forward, the non-played content appears blurry as the frames are forwarded. The exemplary media player 1001 also presents the played content 1002, descriptive text (or other information) for the active content 1004 being played, and a set of additional non-played content 1006, which may be loaded and in queue for play.

In some embodiments, the media player 2001 (FIG. 2) may set a default value of a condition responsible for controlling access to the non-played content 2003 of an opened media file. The default value of the condition may be enforced by a module associated with the instance of the media player 2001. The default value may, for example, be set to prevent or permit access to the non-played content 2003 of the media file. The default value may be set by the initial instance of the media player 2001, and/or the viewer/user.

In some embodiments, the default value of the condition may be manipulated through the media player 2001 and changed from its original or current value. For example, the default value may be manipulated from preventing access to the non-played content 2003 of a media file to permitting such access, regardless of whether such access may allow spoilage or viewing ahead of the non-played content 2003 of the media file. Alternatively, the default value may be manipulated from permitting access to the non-played content 2003 of the media file, to preventing such access and, therefore, preventing the possibility of viewing ahead or “spoiling” the non-played content.

In some embodiments, the media player 2007 prevents the non-played content 2009 from being viewed/played. An indicator within the active content 2010 window of the media player 2007 may show that the media player 2007 is preventing the non-played content 2009 from being played. The indicator may appear according to either the default value of the condition responsible for controlling access to the non-played content 2009, or a manipulated value of the condition. If, for example, the condition is set, according to the default value or a manipulated value, to prevent access to the non-played content 2009, the indicator may appear in the active content 2010 window of the media player 2007. If, for example, the condition is set, according to the default value or a manipulated value, to permit access to the non-played content 2009, the indicator may not appear in the active content 2010 window of the media player 2007.

In some embodiments, the non-played content 2009 may be restricted from play when, for example, the user attempts to accelerate play or skip-over content using the control features/functions of the media player 2007. The user's actions may occur during a time when the active content 2010 is being played, paused, or at anytime after the media file is loaded for play.

In some embodiments, the indicator may be represented according to an icon, a blurred or distorted image, a still-frame or image, a blocked-out frame or image, some other type of restrictive indicator, and/or a frame or image rendered non-viewable. If, according to the condition for controlling access to the non-played content 3003, the user/viewer may be permitted access to the non-played content 3003, the indicator is removed from the active content 3010 window of the media player and the non-played content may become accessible 3009. The non-played content that may become accessible 3009 may, for example, be the next frame (or, image) in sequence or, alternatively, a frame further in sequence if the user/viewer invokes, for example, accelerated play or skip-over.

In some embodiments, the condition for controlling access to the non-played content 3003 may be superseded, providing 3010/preventing 3004 access to the non-played content 3003, according to one or more events. For example, the condition may be superseded, providing 3010 access to the non-played content whenever the user/viewer invokes the control functions/features of the media player 3001 and chooses to accelerate play (e.g., forward), and/or skip-over non-played content. The indicator for preventing access to the non-played content 3003 may be shown in the active content 3004 window but the user may choose to further invoke the control features of the media player 3001 and continue to accelerate play and/or skip-over non-played content 3003. Such events and/or other events, known to or envisioned by one of ordinary skill in the art, may comprise the events for superseding the condition.

In some embodiments, after the indicator is removed from the active content 3010 window of the media player 3007 in response to one or more events that supersede the condition for controlling access to the non-played content 3009, the indicator may appear after some non-played content is played and another attempt is made by the user to invoke the control features of the media player 3001 to forward and/or skip-over non-played content 3003. At that time, the indicator is again shown in the active content window 3004 of the media player 3001 but the user may again choose to further invoke the control features of the media player 3001 and continue to accelerate play and/or skip-over non-played content 3003. In accordance with these events, the indicator may again be removed from the active content 3010 window and the non-played content 3009 may be displayed to the user.

In some embodiments, the condition for controlling access to the non-played content 3003 may be set to permit only a specific number of superseding forwards and/or skip-over requests within a certain time period, session, media file, content restrictions/characteristics, and/or in accordance with user-level permissions.

In some embodiments, the condition for controlling access to the non-played content 3003 may be set such that it may not permit any superseding forwards and/or skip-over requests. In such an instance, the condition would broadly prevent spoilage and/or viewing ahead of non-played content 3003.

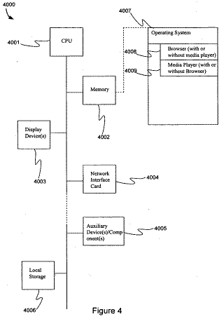

FIG. 4 illustrates an exemplary system block diagram in accordance with the present invention. The exemplary system 4000 for implementing an exemplary embodiment of the present invention comprises a computer processing unit (CPU) 4001, memory 4002, display device(s) 4003, a network interface card (NIC) 4004, auxiliary device(s)/component(s) 4005, and local storage 4006. These elements may communicate over one or more local buses. The CPU 4001 may fetch instructions to execute from memory 4002, where the instructions may be from an operating system 4007 and, further, from a browser 4008 (with or without having an embedded media player) and/or media player 4009 (with or without being embedded in a browser) executing via the operating system 4007. The media player 4009 may receive/fetch media files from local storage 4006 and/or over a network 10 using the NIC 4004 for communication with one or more servers 1030. The media player 4009 may also be embedded within a browser 4008 and may access media files in local storage 4006 and/or over a network 10. The display device(s) 4003 may be a laptop or computer display, TV screen, or other display capable of receiving display signals. The display signals may comprise, for example, one or more frames per second of video or other media content. The media content may be opened and played by the media player 4009. Other auxiliary device(s)/component(s) 4005 may also receive or otherwise communicate via the local bus. For example, a portable media player, mobile telephone, or other auxiliary device may act as a source/sink of media files. The auxiliary device(s)/component(s) 4005,may also be additional display devices and/or media devices capable of supporting the execution of the media player.

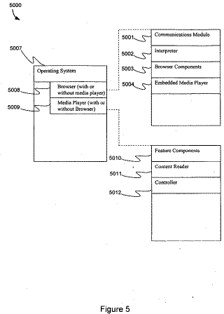

FIG. 5 illustrates an exemplary module block diagram in accordance with the present invention. The exemplary modules 5000 for implementing an exemplary embodiment of the present invention comprise browser modules 5001-5004 and/or media player modules 5010-5012. The browser modules 5001-5004 may comprise a communications module 5001, an interpreter 5002 (e.g., HTML or script/mark-up language interpreter), browser components 5003 (e.g., navigation functions, add-in(s)/on(s), custom user options), and an embedded media player 5004. The media player modules 5010-5012 may comprise feature components 5010, a content reader 5011, and a controller 5012. The browser modules may be used to implement the browser-related features of the exemplary embodiments, while the media player modules may be used to implement the media player-related features of the exemplary embodiments.

In some embodiments, the communications module 5001 receives and transmits data over a network (e.g., network 10) through one or more ports (e.g., HTTP port 80); the interpreter 5002 may interpret scripts/mark-up languages and execute them in accordance with their instructions; the browser components 5003 may implement features such as those for navigating the Internet, supporting add-in(s)/on(s), implementing custom user options and executing in accordance with those options (e.g., permissions, home page preference, bookmarks, script preferences, history preferences, privacy preferences, web page preferences, and/or other Internet/user options); and, the embedded media player 5004 (which may, in some embodiments, be an add-in/on) may play media content in accordance with the present invention as described herein.

In some embodiments, the feature components 5010 may implement features such as media playlist management, media type conversion, media compression/decompression, media playlist/library synchronization, media ripping/burning from/to external storage mediums, and/or media player options (e.g., window size, volume, media quality, play speed); the content reader 5011 may read and decode the contents of a media file, where the media file contents may be represented according to a specific file type and compressed; and, the controller 5012 may implement features for opening, navigating, controlling access to, and/or manipulating media files and/or their content.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

We claim:

1. A computer-implemented method for playing content of a media file, comprising:
opening a media file, wherein the media file is stored locally or remotely;
playing content of the media file at a default speed; and
controlling access to non-played content of the media file according to a condition, wherein the condition is used to prevent spoilage or viewing ahead of the non-played content.

2. The computer-implemented method of claim 1, wherein the condition is set by default to prevent spoilage or viewing ahead of the non-played content.

3. The computer-implemented method of claim 1, wherein the condition has a default value.

4. The computer-implemented method of claim 3, wherein the default value is set to permit spoilage or viewing ahead of the non-played content.

5. The computer-implemented method of claim 3, wherein the default value is capable of manipulation.

6. The computer-implemented method of claim 1, wherein the condition is manipulated during the playing step.

7. The computer-implemented method of claim 1, further comprising the step of preventing spoilage or viewing ahead of the non-played content if the condition is set accordingly.

8. The computer-implemented method of claim 7, wherein the preventing step is superseded and access to the non-played content is allowed.

9. The computer-implemented method of claim 7, wherein the preventing step further comprises the step of displaying a indicator.

10. The computer-implemented method of claim 7, wherein the preventing step further comprises the step of rending the non-played content to be not viewable.

11. The computer-implemented method of claim 9, wherein the indicator is used to indicate the prevention of spoilage or viewing ahead of the non-played content.

12. The computer-implemented method of claim 8, wherein the preventing step is superseded and access to the non-played content is allowed upon receipt of a request to skip-over or forward the content.

13. A system, comprising:
one or more processors;
memory;
one or more programs stored in memory, the one or more programs comprising instructions to:
open a media file, wherein the media file is stored locally or remotely;
play content of the media file at a default speed; and
control access to non-played content of the media file according to a condition, wherein the condition is used to prevent spoilage or viewing ahead of the non-played content.

14. The system of claim 13, wherein the condition is set by default to prevent spoilage or viewing ahead of the non-played content.

15. The system of claim 13, wherein the condition has a default value.

16. The system of claim 15, wherein the default value is set to permit spoilage or viewing ahead of the non-played content.

17. The system of claim 15, wherein the default value is capable of manipulation.

18. The system of claim 13, wherein the condition is manipulated during the playing step.

19. The system of claim 13, further comprising an instruction to prevent spoilage or viewing ahead of the non-played content if the condition is set accordingly.

20. The system of claim 19, wherein the prevent instruction is superseded and access to the non-played content is allowed.

21. The system of claim 19, wherein the prevent instruction further comprises the instruction to display a indicator.

22. The system of claim 19, wherein the prevent instruction further comprises the instruction to render the non-played content to be not viewable.

23. The system of claim 21, wherein the indicator is used to indicate the prevention of spoilage or viewing ahead of the non-played content.

24. The system of claim 20, wherein the prevent instruction is superseded and access to the non-played content is allowed upon receipt of a request to skip-over or forward the content.

25. A computer-readable storage medium storing one or more programs configured for execution by a computer, the one or more programs comprising instructions to:
open a media file, wherein the media file is stored locally or remotely;
play content of the media file at a default speed; and
control access to non-played content of the media file according to a condition, wherein the condition is used to prevent spoilage or viewing ahead of the non-played content.
